(19) United States
(12) Patent Application Publication
(10) Pub. No.: US 2007/0174037 A1
(43) Pub. Date: Jul. 26, 2007

(54) Multiple-microcontroller emulation system, multiple-microcontroller integrated development environment, and method for the same

(75) Inventor: Chuan-Po Ling, Hsin-Chu (TW)

Correspondence Address: TUNG & ASSOCIATES / RANDY W. TUNG, ESQ., 838 W. LONG LAKE RD., SUITE 120, BLOOMFIELD HILLS, MI, 48302, US

(73) Assignee: Chuan-Po Ling

(21) Appl. No.: 11/431,777

(22) Filed: May 10, 2006

Related U.S. Application Data
(63) Continuation-in-part of application No. 11/270,558, filed on Nov. 10, 2005.

(51) Int. Cl. G06F 9/455

(52) U.S. Cl. 703/28

(57) ABSTRACT

The present invention discloses a multiple-microcontroller chip emulation system and an integrated development environment for use therewith, in which the statuses of at least two microcontrollers in the multiple-microcontroller chip are displayed on the screen of a computer to facilitate debugging. A programmer may select one or more microcontrollers and trace program steps in association with the selected microcontrollers, while neglect the other program steps in association with the unselected microcontrollers.

### CROSS REFERENCE

This application is a continuation in part of co-pending Application U.S. Ser. No. 11/270,558 filed on Nov. 10, 2005.

### BACKGROUND OF THE INVENTION

1. Field of the Invention

The present invention relates to a chip emulation system and an integrated development environment (IDE) for use therewith, and in particular to a multiple-microcontroller emulation system, an integrated development environment (IDE) for use therewith, and a method for the same.

2. Description of the Related Art

Microcontrollers (also referred to as “MCUs”, MicroController Units, or referred to as “single-chip microcomputers”)have been widely applied to many industrial and household applications and products. Due to technology development, it has become possible to integrate multiple microcontrollers into one single integrated circuit chip, the “single-chip multi-microcontroller”, to provide more powerful functions.

To develop a program for a microcontroller, an emulation system and an IDE are required, wherein a program is executed until several preset breakpoints and stopped there to monitor the status of the microcontroller, for tracing and debugging the program.

As shown in FIG. 1A, a conventional microcontroller emulation system comprises: a personal computer 10, a microcontroller emulator 12, and a test circuit board 14; the above constitute an in-circuit emulator (ICE). The personal computer 10 is provided with an IDE. The microcontroller emulator 12 comprises: an emulation control logic 124; a full duplex connection port interface 122, for connection with the personal computer 10; a program breakpoint address register 126; and a microcontroller core logic 128. The microcontroller core logic 128 will also be referred to as the “MCU under test” hereinafter; it corresponds to a commercial single-chip microcomputer chip in the future but may be different therefrom because its hardware and program is under development now. The microcontroller emulator 12 tests whether peripheral devices on the test circuit board 14 operate according to the program executed in the microcontroller core logic 128. In this way, the microcontroller emulator 12 emulates the behavior of the microcontroller core logic 128 on the test circuit board 14. In addition, the IDE displays the program steps on a screen of the personal computer 10, to help the programmer trace and debug the program. The programmer can preset one or multiple breakpoints within the program. When a breakpoint is reached, the MCU under test 128 temporarily stops, and the status of the MCU under test 128 at the breakpoint can be read out, so that the programmer may check whether it is as desired.

Referring to FIG. 1B, another conventional microcontroller emulation system is shown, which differs from the conventional system in FIG. 1A in that the emulation control logic 124, the program breakpoint address register 126, and the MCU under test 128 are integrated into a dedicated emulation microcontroller 16. The internal circuit structure of the dedicated emulation microcontroller 16 is shown in FIG. 2A. By means of the IDE provided in the personal computer 10, and through the full duplex connection port interface 122 and the emulation control logic 124, a programmer presets a breakpoint address 164 in the program breakpoint address register 126. During program execution, when the content of a program counter 162 in the MCU under test 128 (the rest of the elements inside the MCU 128 are not shown in detail) is the same as the preset breakpoint address 164, the emulation control logic 124 will stop the MCU 128 from further executing any program step; thus, the status of the MCU 128 at the breakpoint address 164 can be read out.

FIG. 2B shows the case where multiple breakpoint addresses 164 are preset in the program breakpoint address register 126, for a single MCU 128. When the content of the program counter 162 reaches any breakpoint, i.e., when the content of the program counter 162 is the same as anyone of the preset breakpoint addresses 164, the MCU 128 will be stopped at that breakpoint address, and the IDE will read out the status of the MCU 128 at that breakpoint address and display it on the screen of the personal computer 10.

In the abovementioned chip emulation system, what is displayed on the screen of the personal computer 10 when a program stops at a breakpoint is, for example, as shown in FIG. 3. FIG. 3 shows a screenshot similar to that generated by a conventional IDE produced by Keil™. In the figure, at the upper-right part of the screen, a program step display window 101 lists every step in the program, in which the step pointed by an arrow is the breakpoint (for simplicity of the drawing, some of the steps are omitted in the figure). A parameter display window 102 is displayed at the upper-left part of the screen, which shows the statuses of parameters of the MCU 128, so that a programmer may check them to see whether there is any bug in the program. For example, the window 102 displays the content in the registers R0-R7, the content in the accumulator (AC=0-01), the content in the stack pointer (SP=0-6c), the maximum value of the stack pointer (SP_max=0-6c), the content of the program counter (PC=c:0-5A93), the value at a data reference point (DPTR=0-2002), processing time so far (sec=0.00047567), the value of the program status word (PSW=0-01), etc. The program status word includes an overflow bit (ov=0), a zero flag bit (f0=0), a carry bit (cy=0), etc. For simplicity of the drawing, not all of the parameters are shown in the figure. An action record window 105 at the lower-left of the screen displays the actions that the programmer has taken, such as loading the present program from a location in a hard drive, and storing the program to another location, etc. The two memory inquiry windows 106 and 107 at the lower-middle and lower-right part of the screen provide the function for querying the content of a memory location by its name (such as DPTR) or address.

The prior art chip emulation systems and the prior art IDEs, such as the ones described above, are designed for emulation of a single microcontroller. They do not take into consideration the requirements of a multi-microcontroller (MMCU) More specifically, an MMCU includes multiple microcontroller units, but the abovementioned chip emulation system and IDE can not simultaneously test, nor simultaneous display, the program execution statuses of multiple microcontroller units.

Therefore, the present invention proposes a multiple-microcontroller emulation system, an IDE for use therewith, and a method for the same, to overcome the drawbacks in the prior art.

### SUMMARY OF THE INVENTION

An object of the present invention is to provide an MMCU emulation system and an emulation method thereof, wherein an MMCU emulation control logic is provided. The MMCU emulation control logic compares the contents of the program counters of at least two microcontrollers in the MMCU respectively with at least one corresponding breakpoint address, so that a programmer can effectively trace the program execution status of every microcontroller in the MMCU.

Another object of the present invention is to provide an MMCU emulation system and an emulation method thereof, wherein the program steps of each microcontroller can be executed one by one, and an IDE in a computer can instantly reflect the execution status of every microcontroller for the programmer's review.

A further object of the present invention is to provide an IDE for an MMCU, which generates a graphic view on the screen of a computer, and the graphic view displays the statuses of selected parameters of selected microcontrollers in the MMCU according to a programmer's selection, so that it is easier for the programmer to trace and debug a program.

According to an aspect of the present invention, to achieve the abovementioned objects, the present invention proposes an MMCU emulation system and an emulation method thereof. The system comprises an MMCU emulator, which further includes an emulation control logic and a plurality of microcontrollers. The emulation control logic controls the operation of each microcontroller during execution of a program. Each microcontroller has a corresponding program counter, and operates at a timing different from that of another microcontroller. An IDE in a computer sets one or more breakpoints by providing one or more breakpoint addresses in a breakpoint address register via a full duplex connection port interface and the emulation control logic. When the program being executed reaches one of the breakpoints, that is, when the content of one of the program counters is the same as one of the breakpoint addresses, the emulation control logic withholds the operation of all the microcontrollers, and the IDE reads the statuses of the microcontrollers and displays the values of at least two program counters on the screen of the computer for a programmer's review.

According to another aspect of the present invention, an IDE generates a graphic view on the screen of a computer, which displays the statuses of selected parameters of selected microcontrollers in the MMCU according to a programmer's selection, so that it is easier for the programmer to trace and debug a program. The parameters may include, but are not limited to, the values of program counters, accumulators, stack pointers, and flags of the microcontrollers; the flags may include, but are not limited to, a zero flag, an overflow flag, a carry flag, and an alternative carry flag. The graphic view described in this paragraph is not limited to showing the statuses of the parameters at a breakpoint, but may instead be used for showing the statuses of the parameters when a programmer is checking the program step-by-step.

In order to further assist a programmer to trace and debug a program, according to the present invention, a menu is provided for the programmer to select microcontrollers of interest to the programmer. In response thereto, parameters or program steps relating to the selected microcontrollers may be displayed on the screen with emphasis. Or, the program is stopped only when the selected microcontrollers reach a preset breakpoint, but continues to run when unselected microcontrollers reach a preset breakpoint. Or, when the programmer is tracing the program step-by-step, the program stops by every step that relates to the selected microcontrollers, but continuously runs through the steps that relate to the unselected microcontrollers.

For better understanding the objects, characteristics, and effects of the present invention, the present invention will be described below in detail by illustrative embodiments with reference to the attached drawings.

### BRIEF DESCRIPTION OF THE DRAWINGS

FIG. 1A and FIG. 1B are block diagrams schematically showing the architectures of conventional microcontroller emulation systems.

FIG. 2A is a block diagram schematically showing the conventional emulation system for a single microcontroller with a single breakpoint address.

FIG. 2B is a block diagram schematically showing the conventional emulation system for a single microcontroller with multiple breakpoint addresses.

FIG. 3 shows an example of the graphic view displayed on the screen according to prior art.

FIG. 4 is a diagram schematically showing the architecture of the present invention.

FIG. 5 is a diagram schematically showing the internal circuit structure of the MMCU under test according to the present invention.

FIG. 6A is a block diagram showing one embodiment of the. present invention.

FIG. 6B is a block diagram showing another embodiment of the present invention.

FIGS. 7A-7E show examples of the graphic view displayed on the screen according to the present invention.

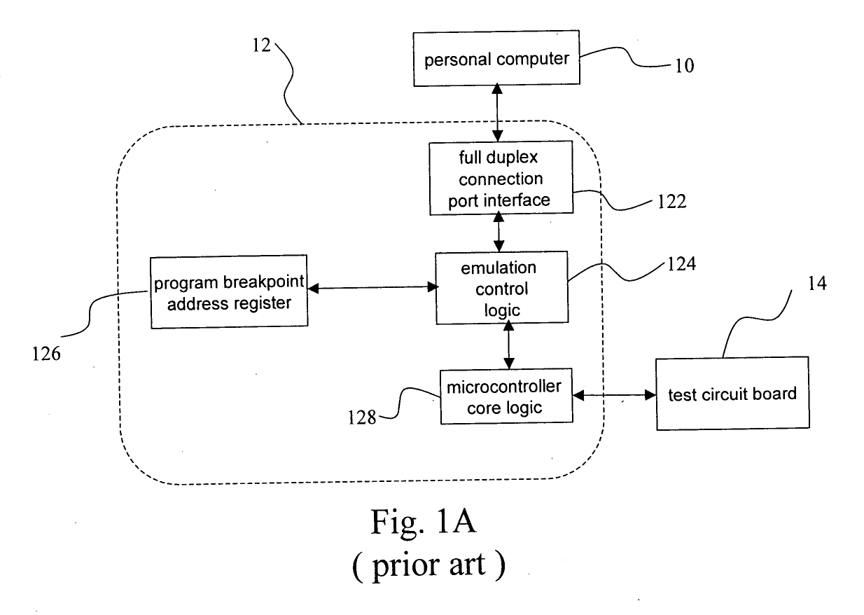

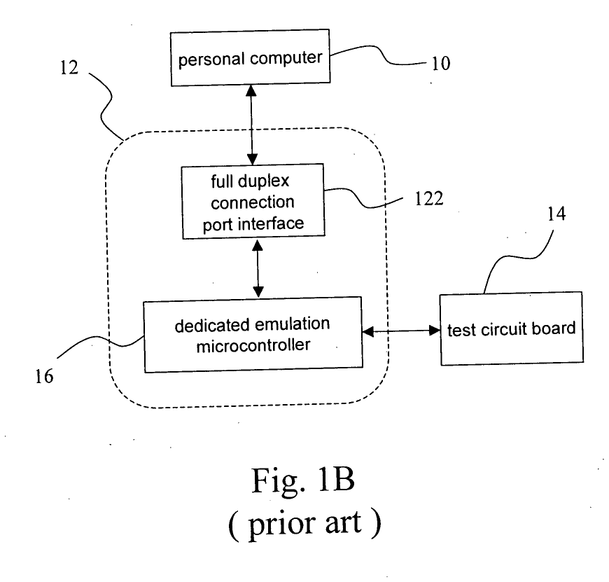

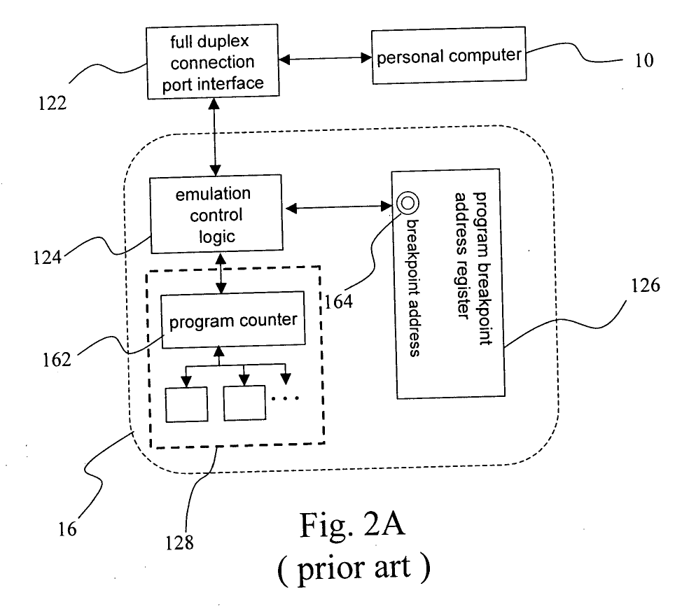

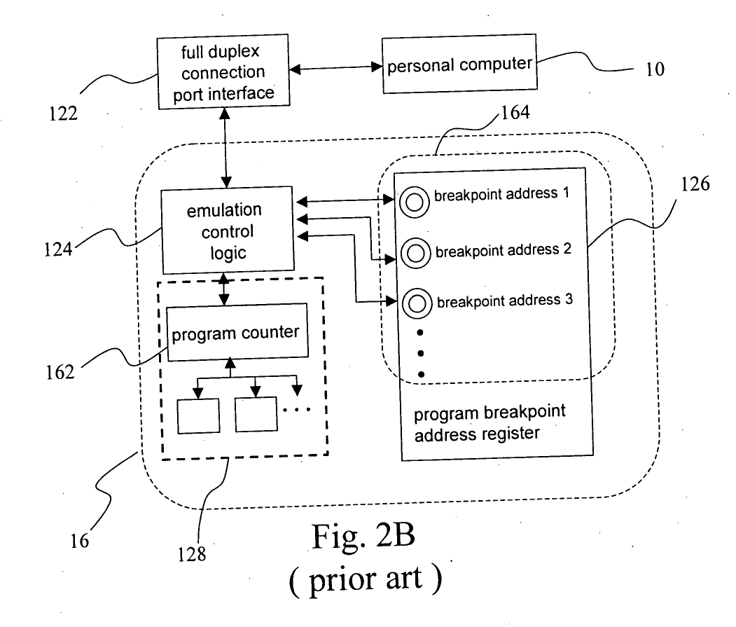

### DESCRIPTION OF THE PREFERRED EMBODIMENT

A first part of the present invention is to provide a multi-microcontroller emulation system and an emulation method thereof, wherein a programmer presets one or several breakpoint addresses to trace the program execution statuses of the microcontrollers in the MMCU, and an IDE in the computer reads the statuses of the microcontrollers at the breakpoint address and informs the programmer to assist program development.

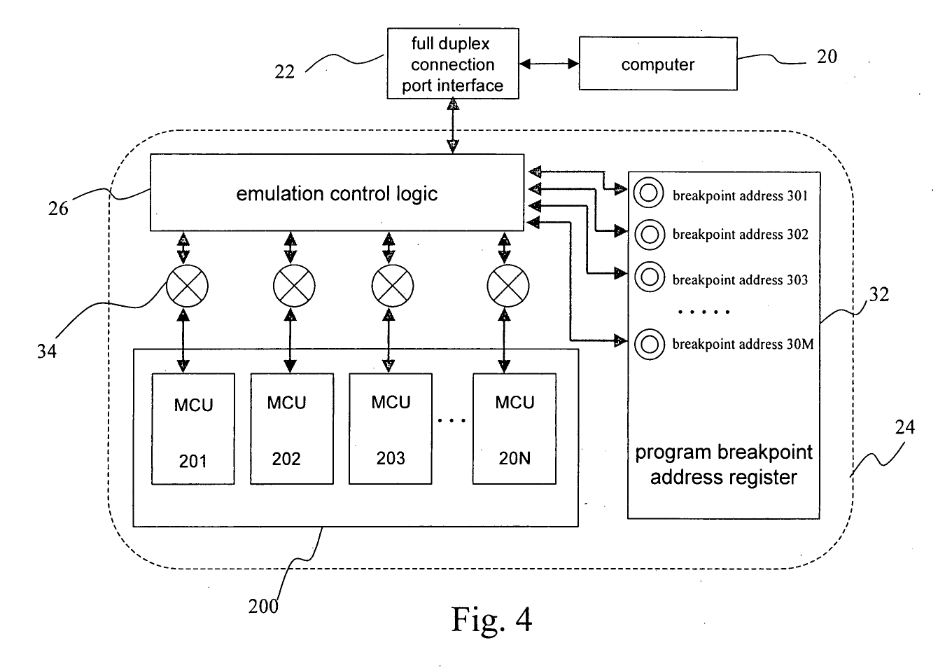

As shown in FIG. 4, the emulation system for an MMCU in the present invention comprises: a computer 20, a full duplex connection port interface 22, and a MMCU emulator 24. The computer 20 has an IDE (Integrated Development Environment) installed therein, for developing programs of the MMCUs. The full duplex connection port interface 22 may be a parallel port, a RS-232 interface, a RS-458 interface, a GPIB interface, an IEEE1394 interface, a USB (Universal Serial Bus) interface, an SCSI (Small Computer System Interface) interface, or an Ethernet network. The MMCU emulator 24 is connected to the computer 20 via the full duplex connection port interface 22. The MMCU emulator 24 further comprises: an emulation control logic 26, a program breakpoint address register 32 having preferably at least two breakpoint addresses 301-30M for setting program breakpoints, and an MMCU under test 200, which includes multiple MCUs 201, 202, 203, . . . , 20N.

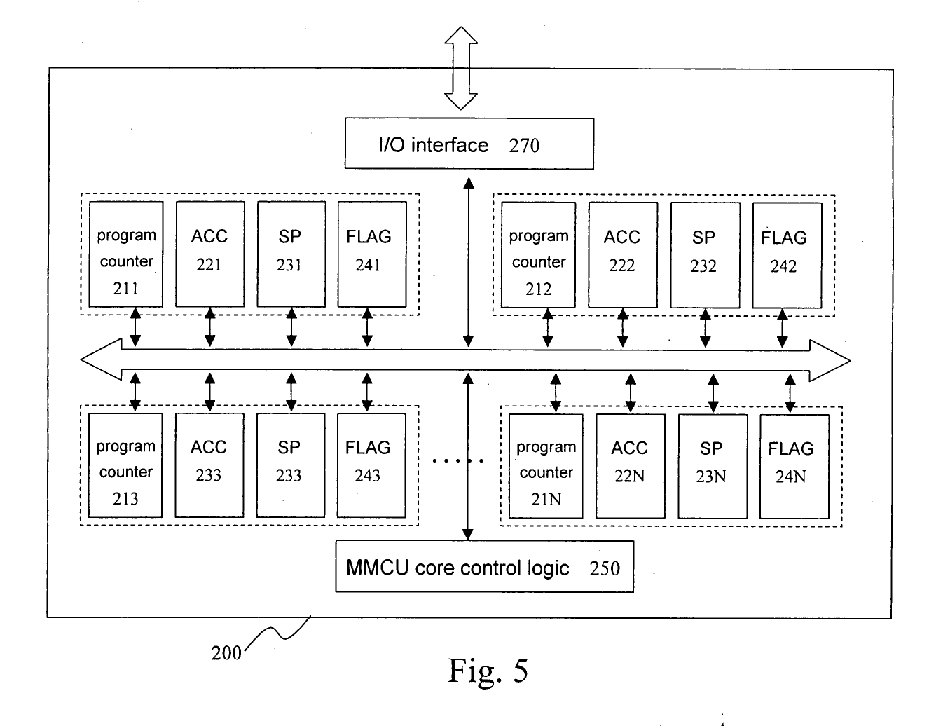

For detailed internal circuit structure of the MMCU under test, an embodiment thereof is shown in FIG. 5. Every MCU includes a corresponding program counter 211, 212, 213, . . . , 21N, a corresponding accumulator (ACC) 221, 222, 223, . . . , 22N, a corresponding stack pointer (SP) 231, 232, 233, . . . , 23N, and a corresponding flag register (FLAG) 241, 242, 243, . . . , 24N. Each flag register may comprise several bits to express multiple flag statuses; for example, the flag register may comprise a zero flag bit to express the number zero, an overflow flag bit to express an overflow condition, a carry flag bit to express an 8-bit carry condition, and an alternative carry flag bit to express a 4-bit carry condition. Each of the MCU may have its own core control logic (such arrangement not shown), or, as shown in the figure, all the abovementioned circuits are controlled by a common MMCU core control logic 250, and every circuit block encompassed by a dash line dynamically cooperates with the common MMCU core control logic 250 to constitute a complete MCU 201-20N. The above internal circuits communicate with the external devices, such as the emulation control logic 26, through an input/output interface 270.

Please refer to both FIG. 4 and FIG. 5. Each of the program counters 211-21N of the MCUs 201-20N may correspond to at least one breakpoint address 301-30M, where N and M are integers not necessarily equal to each other; in other words, one program counter may correspond to more than one breakpoint addresses, or two or more program counters may correspond to one single breakpoint address. The programmer can issue commands from the computer 20 via the full duplex connection port interface 22 to the MMCU emulator 24. The emulation control logic 26 receives the commands and then enables one or a plurality of breakpoints, which respectively correspond to one or a plurality of microcontroller program counters 211-21N, via one or a plurality of breakpoint-enabling switches 34. When a breakpoint-enabling switch 34 is turned ON, a corresponding program counter will persistently be compared with a corresponding breakpoint address 301-30M. When the content of the program counter whose comparison has been enabled is the same as the breakpoint address, the emulation control logic 26 will stop all the microcontrollers. If the breakpoint is not enabled (i.e., breakpoint address. comparison not enabled), neither the corresponding program counter is compared with the breakpoint address nor is any microcontroller stopped at that breakpoint. The emulation control logic 26 can set or clear those breakpoint-enabling switches 34. When a program reaches an enabled breakpoint, the emulation control logic 26 will withhold all the microcontrollers, and send the statuses of all or a portion of the MCUs in the MMCU at that breakpoint to the IDE in the computer 20 via the full duplex connection port interface 22, to be displayed for the programmer's review.

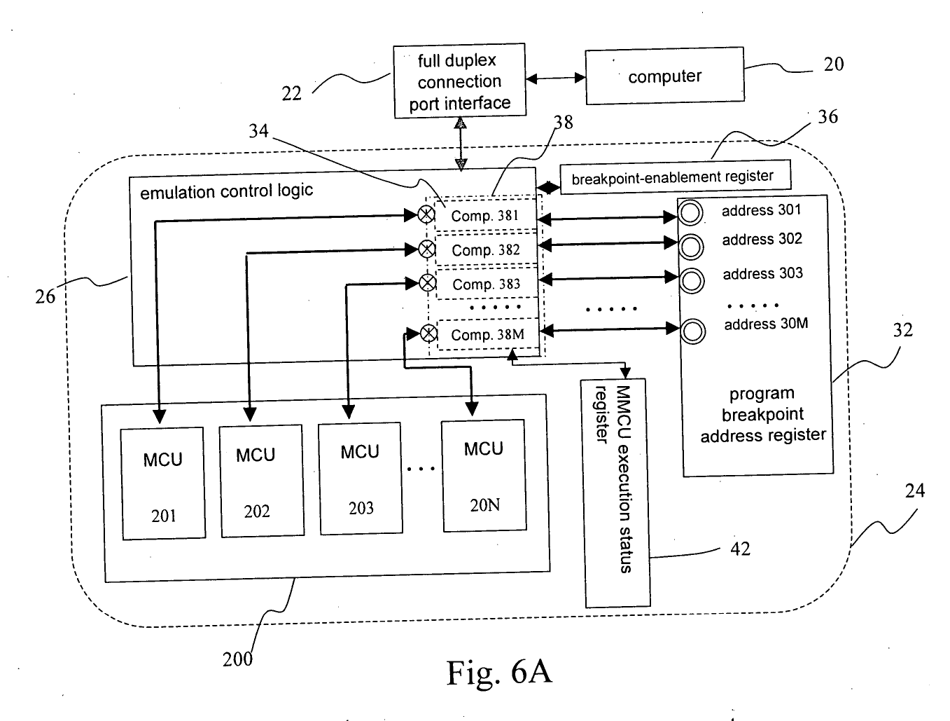

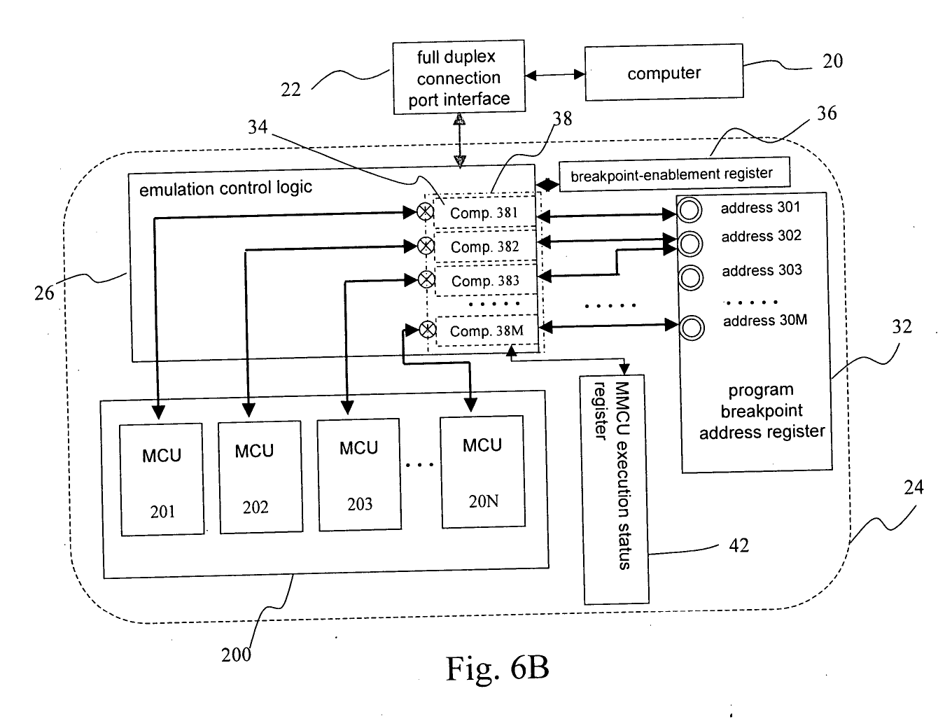

Referring to FIG. 6A for an embodiment of the present invention, which shows a more detailed circuit structure of FIG. 4, the MMCU emulator 24 includes a breakpoint-enablement register 36 and an MMCU execution status register 42, and the emulation control logic 26 includes a comparator circuit 38, which may comprise a plurality of comparators 381-38M for comparison with M breakpoint addresses. It should be noted that this is only one of the possible approaches to achieve the comparison, and there are other alternatives which may be easily conceived by those skilled in this art. For instance, the comparison may be made by means of software instead of hardware. And, if the comparison is made by the hardware arrangement as shown, the number of the comparators does not have to be equal to the number of the breakpoints; a multiplex circuit may be used when the numbers are not equal.

In the embodiment shown in FIG. 6A, the process for the MMCU emulator 24 to withhold all the microcontrollers at a preset breakpoint address 301-30M and send relevant information back to the computer 20 includes the following actions. First, the IDE in the computer 20 presets the breakpoint addresses 301-30M in a program breakpoint address register 32 for the MCUs via the full duplex connection port interface 22 and the emulation control logic 26; the IDE also sets the breakpoint-enablement register 36 to define whether or not any of the breakpoint-enabling switches 34 shall enable the corresponding program counters 211-21N to be compared with the breakpoint addresses 301-30M. When breakpoints are enabled, comparators 381-38M will respectively compare the contents in the program counters 211-21N with the preset breakpoint addresses 301-30M; once the program reaches a preset breakpoint, i.e., the content of any program counter 211-21N is identical to any preset breakpoint address 301-30M, the emulation control logic 26 stops all the microcontrollers, and the statuses of all the microcontrollers will be transmitted to the computer 20 via the emulation control logic 26 and the full duplex connection port interface 22. In the mean time, an MMCU execution status register 42 records the program execution status of every microcontroller, including the exact program counter 211-21N that triggers the present breakpoint, and this information is also transmitted to the computer 20 via the emulation control logic 26 and the full duplex connection port interface 22.

Another embodiment of the present invention is shown in FIG. 6B, which differs from the embodiment shown in FIG. 6A in that each of the MCUs operates at a different timing, and therefore in addition to the arrangement wherein one program counter 211-21N corresponds to one or more breakpoint addresses, it is also possible to arrange in a way that two or more program counters 211-21N correspond to the same breakpoint address. For example, as shown in the figure, the program counter 212 of the MCU 202 and the program counter 213 of the MCU 203 correspond to the same breakpoint address 302. More specifically, under such circumstance, when breakpoints are enabled, the contents of two or more program counters 211-21N in the MMCU 200 are compared with the same breakpoint address 301-30M by the comparators 381-38M, to see whether the value of any program counter reaches the breakpoint. As the MCUs 201-20N respectively operate at separated timings, the exact program counter which triggers the breakpoint can be clearly identified by the MMCU execution status register 42, and this information is transmitted to the computer 20 via the emulation control logic 26. Even though two program counters 211-21N correspond to the same breakpoint address, they are mutually independent and irrelevant, because at the same time clock there is only one MCU operating, and thus only one program counter may trigger a breakpoint. Therefore, the case that two program counters 211-21N simultaneously trigger the same breakpoint address 301-30M will never occur.

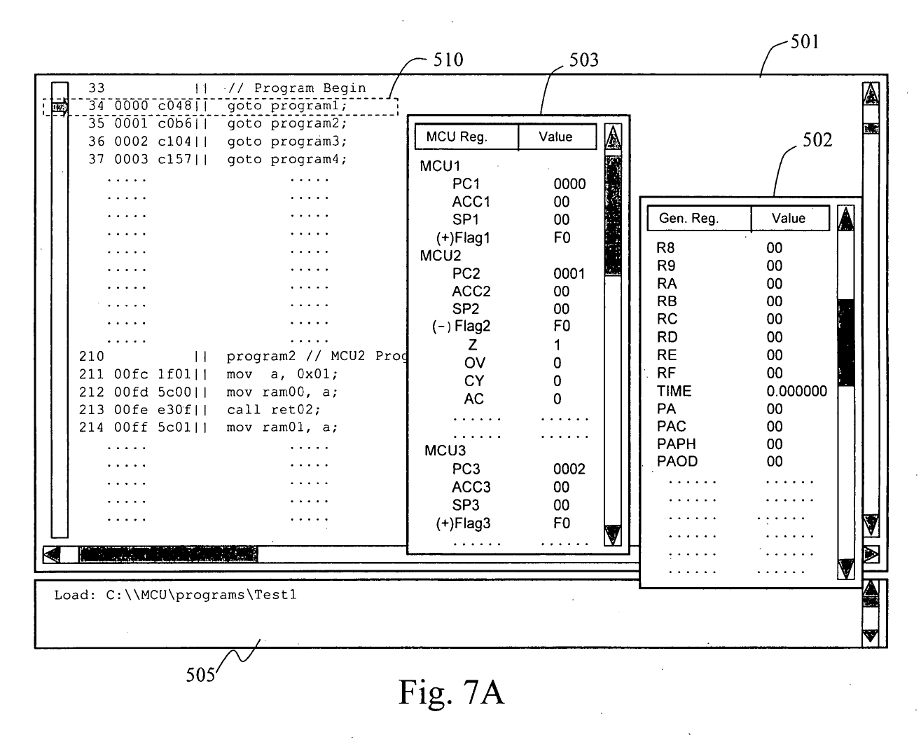

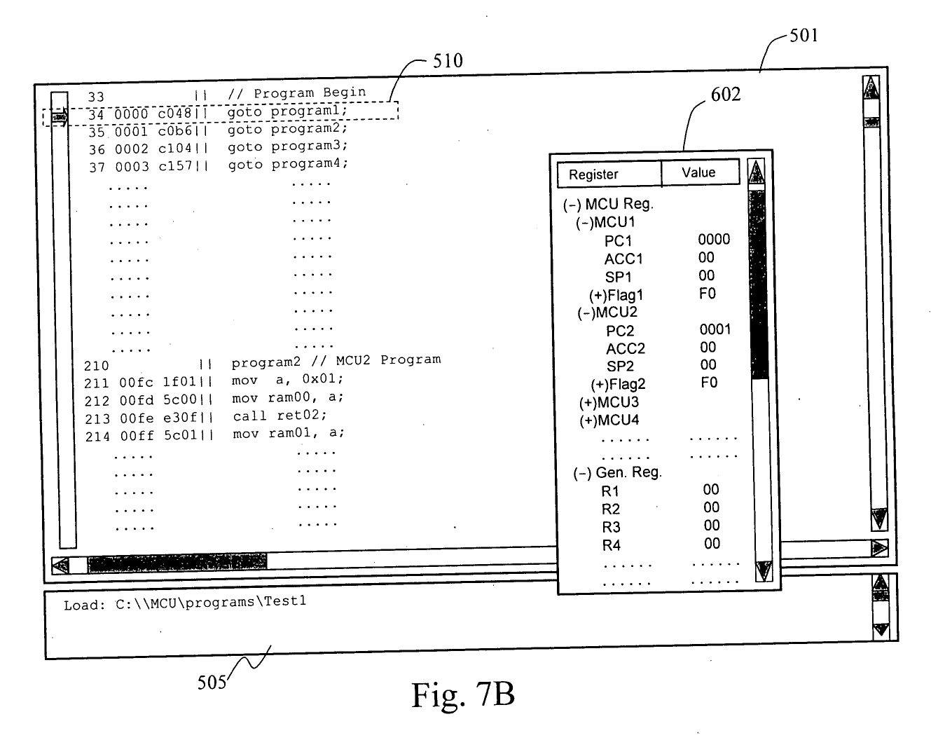

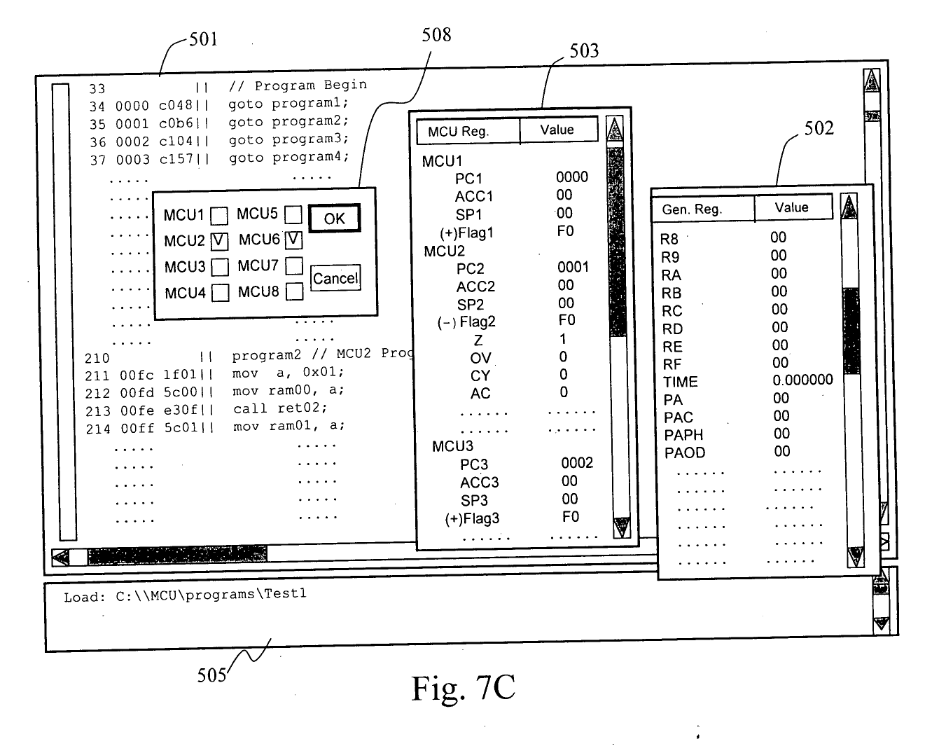

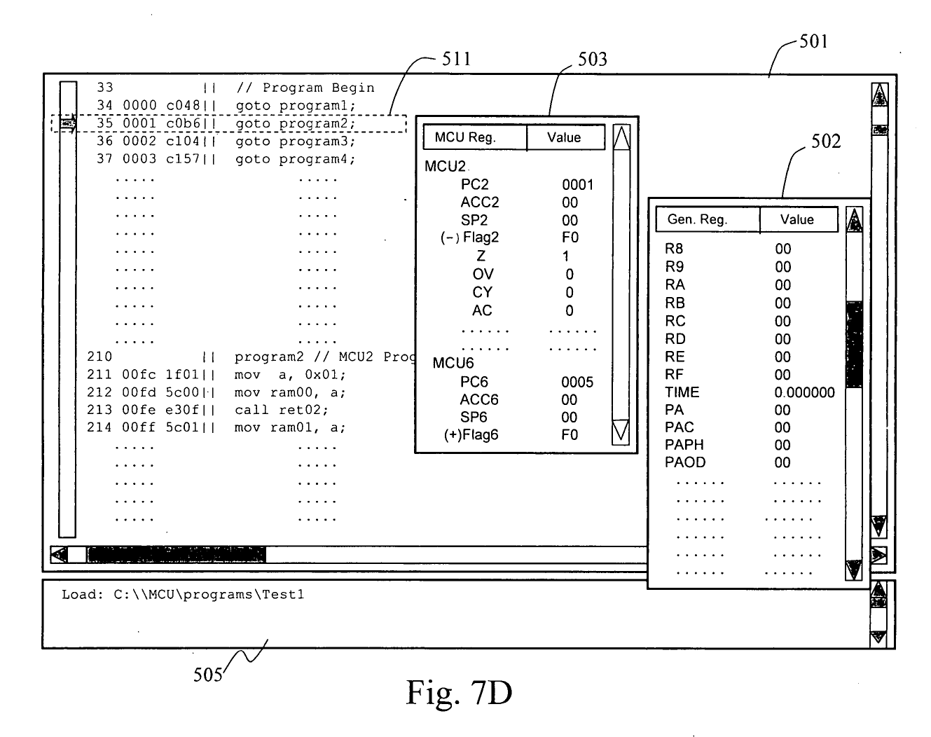

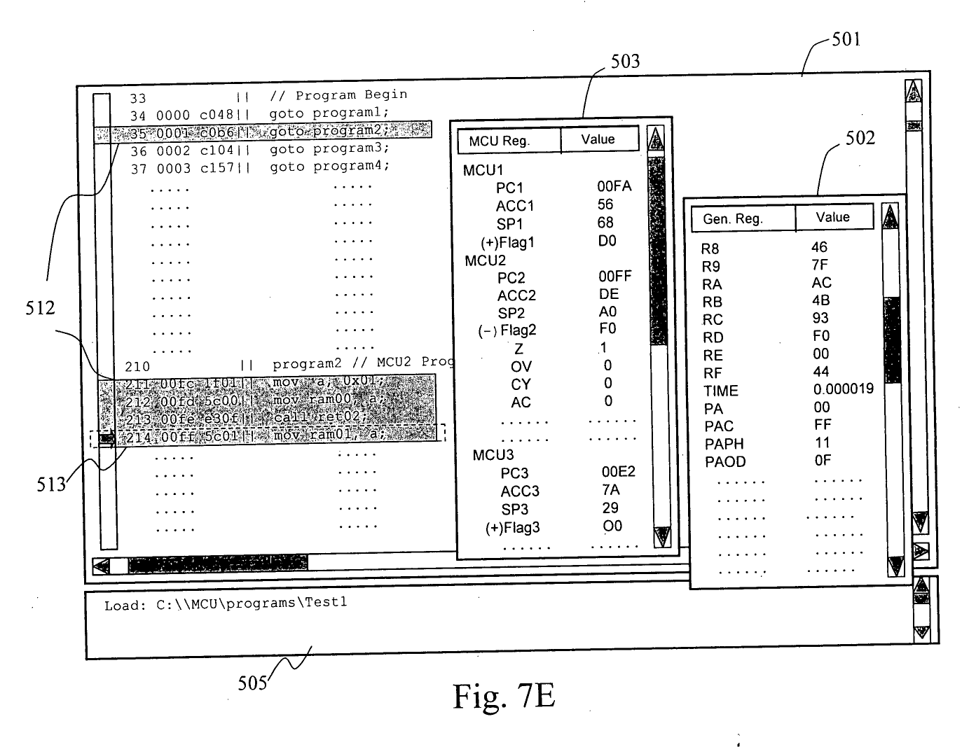

According to a second part of the present invention, the statuses of the MCUs, and other important information, may be displayed on the screen of a computer in a manner that may be easily comprehended by a programmer. An embodiment is shown in FIGS. 7A-7E.

As shown in FIG. 7A, a program step display window 501 is displayed at the upper part of screen, which lists all the steps of a program (for simplicity of the drawing, some of the steps are omitted in the figure). An action window 505 is located at the lower part of the screen, to display the action that the programmer has taken, such as loading the current program from the shown location, etc. A general register display window 502 is shown at the right side of the screen, superimposed on top of the program step display window 501. The general register display window 502 shows the statuses of the registers commonly used by all the MCUs (such as R8-RF shown in the figure), and also shows the program execution time (such as TIME shown in the figure).

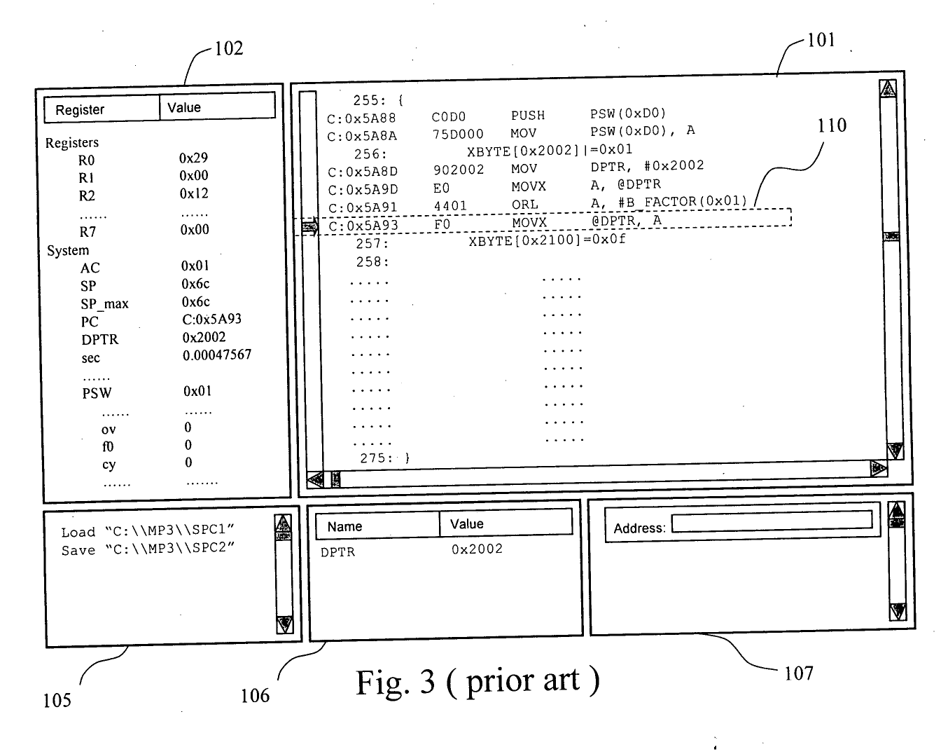

One of the major differences between this embodiment and the prior art shown in FIG. 3 is the MCU status display window 503 shown at the middle-right part of the figure, superimposed on the program step display window 501. This MCU status display window 503 displays the important information of the MCUs in a comprehensive manner to the programmer. The programmer may decide what information is important to him or her; what is shown in the figure is only an illustrative example. More specifically, in the example shown in FIG. 7A, the MCU status display window 503 displays the contents of the program counter (PC1), the accumulator (ACC1), the stack pointer (SP1), and the flag register (Flag1) that correspond to the first MCU (MCU1), and so on. The content of the flag register is actually a combination of several flags; the programmer may check its details by click on the plus sign (+) beside Flag1. As seen from the figure, the flags included in the flag register (Flag2) of the second MCU (MCU2) have been show in detail, which comprise a zero flag, an overflow flag, a carry flag, and an alternative carry flag. In addition to these arithmetic flags, other arithmetic or non-arithmetic flags may also be included (but omitted in the figure). Of all the abovementioned parameters, the content of the program counter is the most important one, which is referred to by the programmer at all times.

Besides the program counter, the accumulator, the stack pointer, and the flag register, each MCU may further have corresponding dedicated registers. For instance, the first MCU (MCUL) may have dedicated registers PA, PAC, PAPH, and PAOD. The contents of such dedicated registers may be displayed in the MCU status display window 503, or as shown in FIG. 7A, displayed in the general register display window 502. When a window is of a size less than the amount of information to be displayed, as shown in the figure, the programmer may pull up or down a scroll bar to adjust the display area of the window.

In addition to the above arrangement, as shown in FIG. 7B, the general register display window 502 and the MCU status display window 503 may be combined into a combined status display window 602, in which the programmer may spread out or hide a group of parameters by clicking on the plus (+) or minus (−) sign. For example, as shown in FIG. 7B, the details of the third and fourth MCUs (MCU3 and MCU4) are hidden. It is also possible to hide all the statuses of the general registers, so that the programmer may focus on what he or she desires to observe.

In the examples shown in FIGS. 7A and 7B, the programmer has preset several breakpoints. The step 34 pointed by an arrow (reference number 510) shown at the upper-left part of the figure is one of the breakpoint. The program stops at this breakpoint so that the programmer may observe the values of the parameters. However, in certain occasions, although the programmer may have already set multiple breakpoints, he or she may wish to focus on solving program issues relating to certain one or more (but not all) MCUs, and therefore does not wish to stop the program at breakpoints that do not relate to those certain MCUs. To this end, as shown in FIG. 7C, a pop-up menu window 508 may be provided on the screen for selection of the MCUs that the programmer wishes to focus on. In the window 508 shown in FIG. 7C, the MMCU includes eight MCUs, but the programmer is only interested in MCU2 and MCU6, so he or she. selects them by checking the boxes corresponding to MCU2 and MCU6. Of course, the selection may be made by other means instead of a pop-up window; for instance, a button or a pull-down menu bar may be provided for such selection.

After selection of the MCUs, and in case the programmer does not change his setting of the breakpoints (i.e., the breakpoints are the same as those originally set in FIGS. 7A and 7B), when the program re-starts or resumes, it will not stop at the breakpoints that do not relate to the selected MCUs. For example, as shown in FIG. 7D, the program does not stop at the step 34 (one of the originally set breakpoints), but instead passes it and stops at the step 35 pointed by an arrow (reference number 511 in the figure), because the latter is a breakpoint step that relates to MCU2.

Moreover, as shown in FIG. 7D, after selection of the MCUs, the IDE may automatically change the display format of the MCU status display window 503 so that it only shows the statuses of the selected MCUs. But of course, it can be arranged so that there is no format change, or the format change is manually done.

All the above examples in FIGS. 7A-7D are described with reference to breakpoints, but the present invention is not limited to that. The present invention may also be applied to the situation where a programmer step-by-step controls the execution of a program, without use of any breakpoint, or in combination of use of breakpoints. In this case, the key feature of the examples shown in FIGS. 7A and 7B is to display the statuses of two or more MCUs on the screen for the programmer's review, while key feature of the examples shown in FIGS. 7C and 7D is to pass the steps that do not relate to the selected MCUs. For example, the graphic view shown in FIG. 7D may be due to the programmer's step-by-step control until step 35. When the program is under step-by-step control by the programmer, according to the present invention, it may be arranged so that the program only goes to the next step that relates to one of the selected MCUs, but passes the steps that relate to the unselected MCUs.

Furthermore, as shown in FIG. 7E, it may be arranged so that the steps that relate to the selected MCUs are displayed with emphasis, as shown by the reference number 512. Of course, the emphasis is not limited to background color as shown in the figure, but may be other methods such as font change, underlines, etc.

The examples of FIGS. 7A-7E are described with reference to an integrated MMCU chip having multiple MCUs therein. However, the same spirit is also applicable to multiple MCUs which are not integrated into one single chip, that is, the graphic views and corresponding examples of FIGS. 7A-7E may be applicable to the case where MCU1-MCU8 are eight different chips.

The features, characteristics and effects of the present invention have been described with reference to its preferred embodiments, which are illustrative of the invention rather than limiting of the invention. Various other substitutions and modifications will occur to those skilled in the art, without departing from the spirit of the present invention. For example, the windows may be displayed side by side without superimposition. Therefore, all such substitutions and modifications are intended to be embraced within the scope of the invention as defined in the appended claims.

What is claimed is:

1. A method in an integrated development environment for tracing the statuses of a plurality of microcontrollers during execution of a program, each of said plurality of microcontrollers having a corresponding program counter, the method comprising:
generating a graphic view on a screen, which displays the values of at least two program counters corresponding to at least two of said plurality of microcontrollers.

2. The method of claim 1, wherein each of said plurality of microcontrollers further having a corresponding accumulator, the method comprising: displaying the values of at least two accumulators corresponding to said at least two microcontrollers.

3. The method of claim 1, wherein each of said plurality of microcontrollers further having a corresponding stack pointer, the method comprising: displaying the values of at least two stack pointers corresponding to said at least two microcontrollers.

4. The method of claim 1, wherein each of said plurality of microcontrollers further having a corresponding flag, the method comprising: displaying the values of at least two flags corresponding to said at least two microcontrollers.

5. The method of claim 4, wherein said flag is one selected from the group consisting of: a zero flag, an overflow flag, a carry flag, an alternative carry flag, and two or more of the above.

6. The method of claim 1, wherein each of said plurality of microcontrollers further having a corresponding accumulator, a corresponding stack pointer, and a corresponding flag, the method comprising: displaying the values of said at least two program counters corresponding to said at least two microcontrollers, the values of at least two accumulators corresponding to said at least two microcontrollers, the values of at least two stack pointers corresponding to said at least two microcontrollers, and the values of at least two flags corresponding to said at least two microcontrollers, by a single window.

7. The method of claim 1, further comprising: providing a menu for selecting at least one microcontroller among said plurality of microcontrollers.

8. The method of claim 7, wherein the value of the program counter corresponding to said selected at least one microcontroller is displayed with emphasis.

9. The method of claim 7, further comprising: displaying program steps corresponding to said selected at least one microcontroller with emphasis.

10. The method of claim 1, further comprising: receiving a breakpoint setting, and stopping said program when the value of anyone of said program counters reaches said breakpoint.

11. The method of claim 7, further comprising: receiving a breakpoint setting, and stopping said program only when the value of said program counter corresponding to said selected at least one microcontroller reaches said breakpoint.

12. The method of claim 7, further comprising: step-by-step stopping said program for steps corresponding to said selected at least one microcontroller, but continuously executing said program for steps corresponding to an unselected microcontroller.

13. A multiple-microcontroller emulation system, comprising:
a multiple-microcontroller emulator, which further includes an emulation control logic and a plurality of microcontrollers, said emulation control logic controlling the operation of each said microcontroller during execution of a program, and each said microcontroller having a corresponding program counter; and
a computer having a screen and communicating with said emulation control logic,
wherein when the value of anyone of said program counters reaches a preset breakpoint, said emulation control logic withholds the operation of each said microcontroller, and said computer displays the values of at least two program counters corresponding to at least two of said microcontrollers at said breakpoint on said screen.

14. The multiple-microcontroller emulation system of claim 13, wherein said computer provides a menu for selecting at least one microcontroller among said plurality of microcontrollers.

15. The multiple-microcontroller emulation system of claim 14, wherein said emulation control logic withholds the operation of each said microcontroller only when the value of the program counter corresponding to said selected at least one microcontroller reaches said preset breakpoint.

16. The multiple-microcontroller emulation system of claim 14, wherein said emulation control logic step-by-step withholds the operation of each said microcontroller at program steps that correspond to said selected at least one microcontroller, but does not withhold the operation of each said microcontroller at program steps that correspond to an unselected microcontroller.

17. An emulation method for a multiple-microcontroller which includes a plurality of microcontrollers, each of said microcontrollers having a corresponding program counter, the method comprising:
setting a breakpoint by providing a breakpoint address;
comparing the content of at least one program counter with said breakpoint address during execution of a program, to determine whether said breakpoint is reached;
withholding said plurality of microcontrollers when the value of said at least one program counter reaches said breakpoint; and
displaying the statuses of at least two of said plurality of microcontrollers.

18. The emulation method of claim 17, wherein said statuses include the values of the program counters corresponding to said at least two microcontrollers.

19. The emulation method of claim 18, wherein each of said plurality of microcontrollers further has a corresponding accumulator, a stack pointer, and a flag, and wherein said statuses further include one selected from the group consisting of: the values of the accumulators corresponding to said at least two microcontrollers, the values of the stack pointers corresponding to said at least two microcontrollers, the values of the flags corresponding to said at least two microcontrollers, and two or more of the above.

20. The emulation method of claim 17, further comprising: providing a menu for selecting at least one microcontroller among said plurality of microcontrollers.

21. The emulation method of claim 20, wherein said step of withholding said plurality of microcontrollers is performed only when the value of the program counter corresponding to said selected at least one microcontroller reaches said breakpoint.

22. The emulation method of claim 17, further comprising: step-by-step withholding said plurality of microcontrollers at program steps that correspond to said selected at least one microcontroller, but continuously executing said program at program steps that correspond to an unselected microcontroller.
